(19) United States
(12) Patent Application Publication
(10) Pub. No.: US 2009/0052973 A1
(43) Pub. Date: Feb. 26, 2009

(54) WRITING INSTRUMENT WITH COMPACT SHEET DISPENSER

(75) Inventor: David C. Windorski, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/843,235

(22) Filed: Aug. 22, 2007

(51) Int. Cl. B43K 29/12

(52) U.S. Cl. 401/195

(57) ABSTRACT

A writing instrument having a central axis is provided. It includes (a) a barrel portion having opposing first and second ends, an exterior grip surface in between, and a first internal cavity; (b) a marking element extending from the first end of the barrel portion and disposed in the first internal cavity; and (c) a dispensing portion having opposing first and second ends, the first end in communication with the second end of the barrel portion.

### CROSS REFERENCE TO RELATED APPLICATION

This application is related to an application having an attorney docket number 63062US002, entitled Compact Sheet Dispenser, both applications being filed even date herewith.

### BACKGROUND

3M Company has introduced a wide variety of products and services to help consumers and office workers communicate, organize, and manage their information. For example, Post-it® Flags, has proven to be an extremely useful tool for marking specific areas of documents, magazines, books, and the like. In general, the flag (also referred to as an “index”), is a polymeric or paper based material having a first and second end portions and first and second opposing major surfaces. The flag includes a repositionable adhesive one of a first or a second portion of its first or second major surface. In a polymeric flag, the first portion is typically transparent and is larger in size than the second portion, which is generally brightly colored. A plurality of flags is releaseably adhered to one another in a fan-fold (also referred to as “z-stacked”) configuration such that the repositionable adhesive in alternating flags is at alternating ends of the stack. The flags have been integrated into writing instruments such as pens and highlighters. For example, 3M Company sells Post-it® highlighters and Post-it pens. These integrated writing instruments provide a portable and convenient way to have flags readily available for a user wherever (s)he goes. Flags integrated into pens and highlighters are described in, e.g., U.S. Pat. No. 6,719,472 (Windorski et al.), US Patent Application Publications US 2004/0234326 and US 2005/091114, and in Japanese Patent Application Publication Nos. JP2000025385 and JP11139081.

Similarly, the Post-it® Durable Tabs, such as product no. 686-2GO, have found extensive use by consumers in many applications, such as for marking notebooks, labeling binders, and filing projects. Typically, the durable tabs are made of a stiffer polymeric material than the flags described in the preceding paragraph. The tabs are releaseably adhered to one another in a fan-fold configuration and dispensed from a substantially C-shaped dispenser. The stack of durable tabs is directly adhered to a bottom surface of the dispenser. The durable tabs have a visually transparent first portion, a repositionable adhesive on one major surface, and a brightly colored, adhesive-free second portion.

The Post-it® Pop-up page markers provide a combination of stacks of repositionable, paper-based notes and stacks of flags in a dispenser. Each stack of notes or flags is adhered to a carrier, as described in US Patent Application Publication US 2007/0175913.

Further information on the Post-it® products described above can be found at www.Post-it.com. While the foregoing products are very useful, there is continued innovation by those skilled in the art to provide other products.

### SUMMARY

The present invention provides a compact, non-shuttling sheet dispenser with a stack of sheets that are releaseably adhered to one another in a fan-fold configuration. Each sheet has from about 45% to 55% adhesive coverage. In a preferred embodiment, each sheet has about 50% adhesive coverage.

In one aspect, the present invention pertains to a sheet dispenser having a longitudinal axis and comprising or consisting essentially of (a) an upper member having a centrally located slot disposed transverse to the longitudinal axis, the slot having a width dimension as measured parallel to the longitudinal axis, (b) a lower member at least temporarily attached to the upper member forming a housing; and (c) a stack of sheets, the stack having a length dimension along its major axis, each sheet in the stack being releasably adhered to one another in a fan-fold configuration and disposed in the housing, each sheet comprising (i) a tab end portion, an adhesive end portion, and opposing first and second surfaces, and (ii) a coating of repositionable adhesive disposed on the adhesive end portion of the second surface of each sheet, the adhesive covering from about 45% to 55% of the second surface, wherein a bottom most sheet in the stack and is not attached to the lower member of the housing, and wherein the slot width is from about 1% to 10% of the length of the stack.

In another aspect, the present invention pertains to a sheet dispenser having a longitudinal axis and comprising or consisting essentially of (a) an upper member having a centrally located slot disposed transverse to the longitudinal axis and first and second upper walls attached respectively to opposing first and second end walls, wherein the slot has a width dimension disposed parallel to the longitudinal axis; (b) a lower member at least temporarily attached to the upper member forming a housing; and (c) a stack of sheets, the stack having a length dimension, each sheet in the stack being releasably adhered to one another in a fan-fold configuration and disposed in the housing, each sheet comprising (i) a tab end portion, an adhesive end portion, and opposing first and second surfaces, and (ii) a coating of repositionable adhesive disposed on the adhesive end portion of the second surface of each sheet, the adhesive covering from about 45% to 55% of the second surface. The dispenser has a length, as measured from a first lateral end wall to a second lateral end wall, that is at most 110% of the length of the stack. And a bottom most sheet in the stack and is not attached to the lower member of the housing.

In yet another aspect, the present invention pertains to a writing instrument having a central axis and comprising or consisting essentially of: (a) a barrel portion having opposing first and second ends, an exterior grip surface disposed therebetween, and a first internal cavity; (b) a marking element extending from the first end of the barrel portion and disposed in the first internal cavity; and (c) a dispensing portion having opposing first and second ends, the first end of the dispensing portion in communication with the second end of the barrel portion, the dispensing portion comprising: (i) a sheet dispenser comprising a cover having (1) a top joined by two substantially symmetrical sidewalls and a rear, each sidewall having a curved profile, the rear abutting the second end of the dispenser portion, (2) a slot disposed about midway along the top and transverse to the central axis of the writing instrument, and (3) a securing mechanism for attaching to the cover to the dispensing portion; and (ii) a lower member integrated into the dispenser portion such that when the cover is attached to the dispensing portion, a housing is formed between the cover and the lower member; and (iii) a second internal cavity adjacent to the lower member of the dispenser and in communication with a portion of the first cavity.

One advantage of the present invention is that because the sheet dispenser is a non-shuttling dispenser, it is more compact (i.e., has a smaller footprint) than the dispenser described in U.S. Pat. Nos. 4,770,320; 4,907,825; 6,719,472 and 6,837,395 where the stack typically shuttles from one end wall to the opposite end wall when a sheet is removed. Thus, the inventive dispenser can be integrated into writing instruments, which inherently has limited space, at a smaller footprint. Also, as a stand alone dispenser, the compactness of the inventive dispenser allows for efficient use of space, which becomes more and more important for many people, including on-the-go workers, who may not have a dedicated work area but instead move from one work area to another. Such on-the-go workers have a practical limit as to the amount and size of material that can be manually transported to and from the various work areas.

As used in this document, the term “nonshuttling dispenser” generally means that upon initiating the removal of a first sheet in the stack through the slot, the next subsequent sheet also begins the dispensing process by moving into the slot without requiring the stack to first move from one end wall to an opposing end wall of the dispenser. In this way, the end walls of the dispenser that defines the length of the dispenser is only slightly larger than the length of the stack of sheets.

### BRIEF DESCRIPTION OF THE DRAWINGS

The present invention can be better explained with reference to the drawings, wherein:

FIG. 1A depicts an enlarged sectional side view of a prior art sheet dispenser having a stack of sheets in a first position with a first sheet within the stack extending through a slot in the sheet dispenser;

FIG. 1B depicts an enlarged sectional side view of the prior art dispenser of FIG. 1A, wherein the stack of sheets is in a second position with most of the first sheet extending through the slot and attached to a second sheet in a relaxed position;

FIG. 1C depicts an enlarged sectional side view of the prior art dispenser of FIG. 1A, wherein the stack of sheets is in a second position with most of the first sheet extending through the slot and a portion of the second sheet extending through the slot;

FIG. 1D depicts an enlarged sectional side view of the prior art dispenser of FIG. 1A, wherein the stack of sheets is in a second position, the first sheet is completely removed from the sheet dispenser and disconnected from the second sheet, and a portion of the second sheet is extending through the slot;

FIG. 2 is a side view of an exemplary stack of sheets of the present invention having about 50% adhesive coverage, the stack being expanded in an accordion-like manner;

FIG. 3A depicts an enlarged sectional side view of one exemplary sheet dispenser of the present invention having a stack of sheets of FIG. 2 with a first sheet in the stack extending through a slot;

FIG. 3B depicts an enlarged sectional side view of the dispenser of FIG. 3A where a first sheet is being removed such that most of the first sheet extends through the slot and a portion of a second sheet is extending through the slot;

FIG. 3C depicts a perspective view of the dispenser of FIG. 3A;

FIG. 4 depicts a perspective view of another embodiment of the present invention where the sheet dispenser has been integrated into a writing instrument;

FIG. 5 depicts a partial exploded view of the embodiment of FIG. 4;

FIG. 6 depicts a perspective view of an inside of a cover of the embodiment of FIG. 4; and

FIG. 7 depicts a cross-sectional view of embodiment of FIG. 4.

The drawings present the invention by way of representations and not limitation. Numerous other modifications and embodiments can be devised by one skilled in the art which fall within the scope and spirit of the principals of this invention. The figures are idealized, are not drawn to scale, and are intended merely for illustrative purposes.

### DETAILED DESCRIPTION

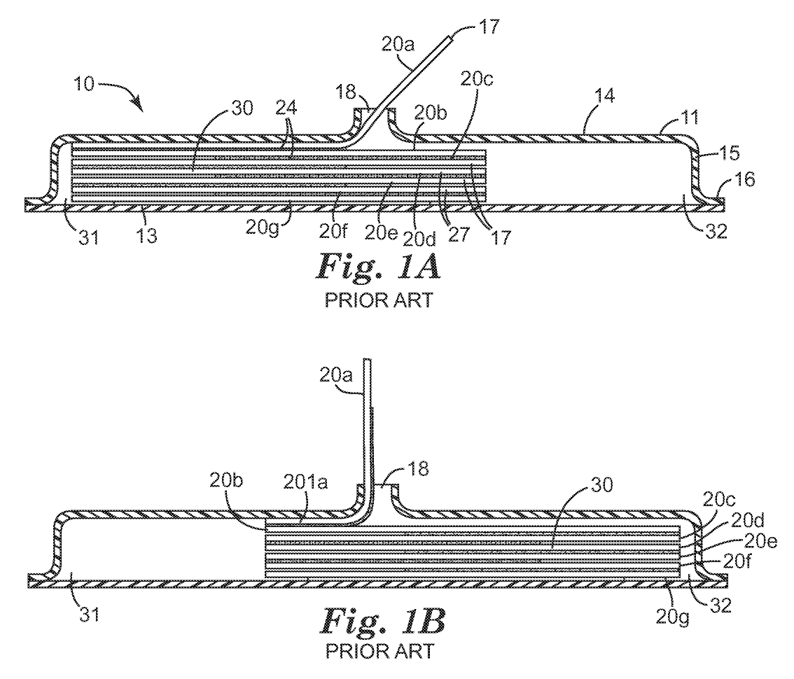

An exemplary prior art sheet dispenser is shown in FIG. 1A. Sheet dispenser 10 comprises housing having an upper housing portion 11 attached to a lower housing portion 13. Upper housing portion has an upper surface 14 and side walls 15 suitable for containing a stack of sheets. Upper housing portion may be temporarily or permanently attached to lower housing portion 13 along perimeter 16. Sheet tab portion 17 extends from the dispenser through slot 18 in upper housing portion. A stack of sheets 30 is positioned within the housing of the sheet dispenser. The stack of sheets comprises, for ease of discussion, seven individual sheets referred to herein as sheets 20a to 20g. As a user removes first individual sheet 20a from the dispenser, the stack moves from a first position 31 towards a second position 32 within the dispenser. FIGS. 1B to 1D below further describe the shuttling motion. U.S. Pat. No. 4,770,320 (Miles et al.) also describes the shuttling motion.

As shown in FIG. 1B, the stack of sheets moves to second position 32 due to the partial removal of first individual sheet 20a from the dispenser. At this stage of the sheet removal process, portion 201a of first individual sheet 20a remains attached to second individual sheet 20b positioned immediately below first individual sheet 20a. As first individual sheet 20a is further removed from the dispenser, a pulling force is exerted on second individual sheet 20b to force a portion of second individual sheet 20b through slot 18 along with portion 201a of individual sheet 20a. Such a configuration is shown in FIG. 1C.

In FIG. 1C, portion 202b of second individual sheet 20b is positioned near the mouth of slot 18. As first individual sheet 20a is pulled from the dispenser, adhesive layer 24a on a lower surface of first individual sheet 20a remains adhered to individual sheet 20b and causes portion 202b of second individual sheet 20b to exit slot 18. As first individual sheet 20a is further removed from the dispenser end portion 202b of second individual sheet 20b moves closer to exit slot 18.

FIG. 1D depicts a final stage in the shuttling motion, wherein the stack of sheets is in second position 32, first individual sheet 20a has been completely removed from the dispenser and disconnected from second individual sheet 20b, and a portion of second individual sheet 20b extends through slot 18. At this stage, the stack of sheets is in position to shuttle back to first position 31 when individual sheet 20b is fully removed from the dispenser. This prior art dispenser has a length that is longer than that of the stack of sheets by a distance generally denoted as reference “L”.

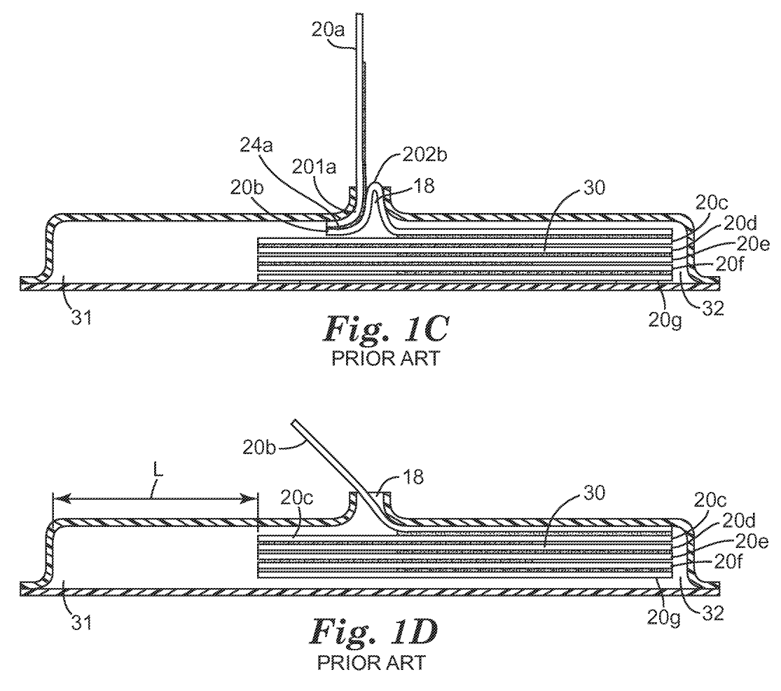

FIG. 2 shows a side view of an exemplary stack 130 of sheets releaseably adhered to one another in a fan-fold configuration and, for purposes of discussion, expanded in an accordion-like manner. Again, for ease of discussion, the stack includes seven sheets, 120a to 120g. Each sheet has a tab end portion and an adhesive end portion. For example, first sheet 120a has a tab end portion 120ax and adhesive end portion 120ay. Similarly, second sheet 120b has a tab end portion 120bx and adhesive end portion 120by. Each sheet also includes opposing first and second surfaces. The first surface is adhesive free and preferably writeable. An adhesive coating 124 is disposed on the second surface and at the adhesive end portion. The tab end portion is adhesive free on both of its first and second surfaces. A plurality of sheets is stacked together such that the adhesive on any two adjacent sheets lie at opposing ends of the stack. In one embodiment, the sheets and the resulting stack of sheets are rectangular. The stack has a length that is equal to its longest side.

At most, adhesive coating 124 covers about 45% to 55% of the surface area of the second surface of the sheet. Preferably the adhesive covers about 50% of the surface area. At an adhesive coverage area greater than about 55%, the stack of sheet will no longer be able to fan out in like an accordion because of the adhesive overlap from one sheet to the next subsequent sheet. Because of the fan-fold configuration, the overlap occurs at the midsection of the stack. Thus, a stack of sheets where each sheet has about 60% adhesive coverage would result in a stack that is essentially a block of sheets. While the present invention is operable where individual sheets have adhesive coverage of 60%, the force required to dispense such a sheet from the stack can be excessively high, which is an undesirable feature for the consumer. Furthermore, in a flag application wherein the sheet is typically used to mark or to index a document, each sheet needs to have a sufficient amount of adhesive so as to remain adhered to the document. Thus, while the present invention is operable with a sheet having less than 45% adhesive coverage, such a sheet may not be as useful in a flag-type application.

Optionally, the tab end portion of the sheet is brightly colored to highlight the area of the document that has been marked. Any color can be used, so long as it is capable of attracting a consumer's attention. If desired, the tab end portion can also include indicia or graphics. In one embodiment, the adhesive end portion is substantially transparent, so as not to obscure any text present on a document that may happen to lie underneath the sheet. The sheet can be made of a variety of materials including paper, synthetic paper, and polymeric films. In a preferred embodiment, the sheet is a polymeric film such as, but not limited to, cellulose acetate and polypropylene.

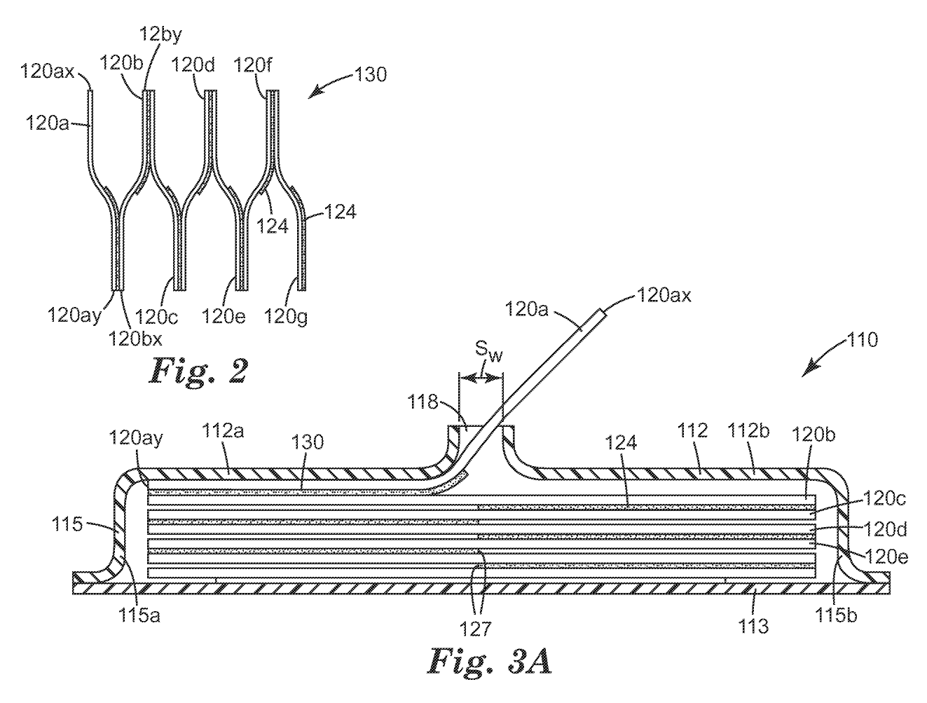

FIGS. 3A and 3B depict enlarged sectional side views of one exemplary sheet dispenser of the present invention 110 equipped with a stack of sheets 130. Along its length, the dispenser has a longitudinal axis, generally denoted as reference line 125. The dispenser has a second axis that is disposed transverse to the longitudinal axis, the transverse axis being denoted as reference line 128. The dispenser includes an upper member 112 having a centrally located slot 118 disposed transverse to the longitudinal axis at about the midpoint along the length of the dispenser. The slot divides the upper member into two substantially equal portions. A first portion includes a first upper wall 112a. The second portion includes a second upper wall 112b. Four lateral walls 115 extend from the upper walls. The lateral walls include two opposing end walls, a first end wall 115a and a second end wall 115b. The distance between the two end walls defines the length of the dispenser. The dispenser includes a lower member 113. The upper member is at least temporarily attached to the lower member via the lateral walls to form a housing.

Each sheet in the stack has about 50% adhesive coverage, although as previously stated, the adhesive coverage can be from about 45% to 55%. As shown best in FIG. 3A, when the stack of sheets is in a non-dispensing state, each of the first and second upper walls, 112a and 112b respectively, contact more than about 40% of the surface area of the top most sheet 120a. A first sheet 120a in the stack has its tab end portion 120ax extending through the slot. The adhesive end portion 120ay remains inside the housing such that the repositionable adhesive 124 of the first sheet is in contact with the tab end portion of a second sheet 120b. The point at which the tab end portion meets with the adhesive end portion is referred to herein as the “adhesive line” or an “interface” and is generally denoted as reference line 127. The interface lies underneath the slot. FIG. 3A shows the interface lies at about the middle of the slot, although it can lie anywhere along the slot width, as further described below.

In FIG. 3B, as the first sheet 120a is being removed form the dispenser, a pulling force is exerted on the second sheet 120b to force a portion of the second sheet, in this case the tab end portion 120by, into the slot. Thus, upon removal of the first sheet from the stack, a next adjacent sheet also begins the dispensing process by folding in the slot. The stack does not have to shuttle to a lateral end wall before the next sheet begins the dispensing process as shown in the prior art dispenser of FIGS. 1A to 1D. While the stack 130 of sheets may move side to side from one lateral end wall to the next, because of the amount of adhesive coverage on each sheet and because of the tight tolerance between the length of the stack and the length of the dispenser, the stack does not shuttle as described in FIGS. 1A to 1D during dispensing.

FIG. 3C shows a perspective view of the dispenser of FIGS. 3A and 3B. The dispenser has a slot width, labeled as SW, parallel to the longitudinal axis 125. In one embodiment, the slot width is from 1% to 10% of the length of the stack of sheets. In another embodiment, the slot width is from 1% to 5% of the length of the stack of sheets. The slot has a length that is sufficient large to allow an individual sheet to extend through the slot. In one embodiment, the slot length is slightly less than the distance between the two lateral walls that lie parallel to the longitudinal axis 125. The dispenser has a length that is substantially equal to the distance between the two lateral end walls 115a and 115b. The dispenser has a length that is at most 110% of the length of the stack of sheets, thereby minimizing the footprint of the dispenser.

The exemplary sheet dispenser as shown in FIGS. 3A, 3B, and 3C has a rectangular shape and is suitable for dispensing rectangular sheets. It should be noted that the sheet dispensers, sheets and the resulting stack of sheets of the present invention may have any other shape. Suitable alternative shapes include, but are not limited to, square, circular, oblong or ellipse, rhombus, trapezoidal, barbell, diamond, or any other shape. In any of these shapes, the stack of sheets will have a length that is equal to the longest linear dimension of the stack. For example, in the case of a square stack, the longest linear dimension of a square stack is the diagonal of the square. For a circular stack, the longest linear dimension is the diameter. For an oblong or elliptical stack, the longest linear dimension is its major axis.

Further, the sheet dispenser is described as having separate upper and lower members. It should be noted that the upper and lower member can be formed integrally and have an opening therein for inputting a new stack of sheets. The dispenser may be made from a variety of materials including, but not limited to, plastic, paper, glass, metal, or a combination thereof. Desirably, the dispenser is formed from a moldable plastic material. In one embodiment of the present invention, the upper member comprises a molded plastic material and the lower member comprises a paper substrate. In some cases, it is desirable for the upper member to be formed from a transparent material so that a user can see the interior of the sheet dispenser.

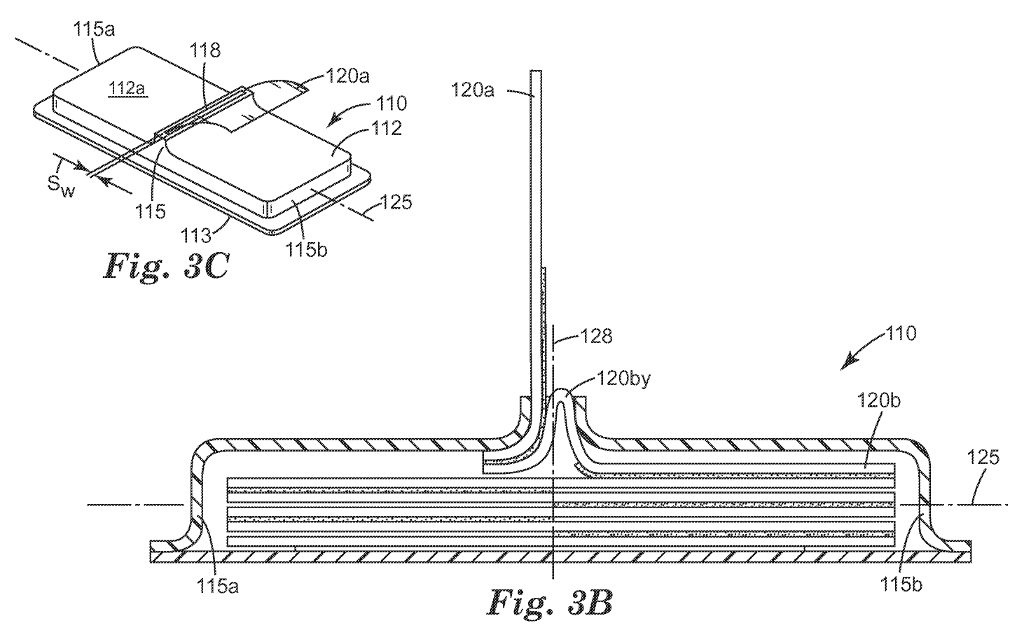

Turning now to another aspect of the present invention, FIGS. 4 to 7 depict various views of a writing instrument integrated with the dispenser of the present invention. An illustrative writing instrument includes, but is not limited to, a highlighter, a pen, a marker and a pencil.

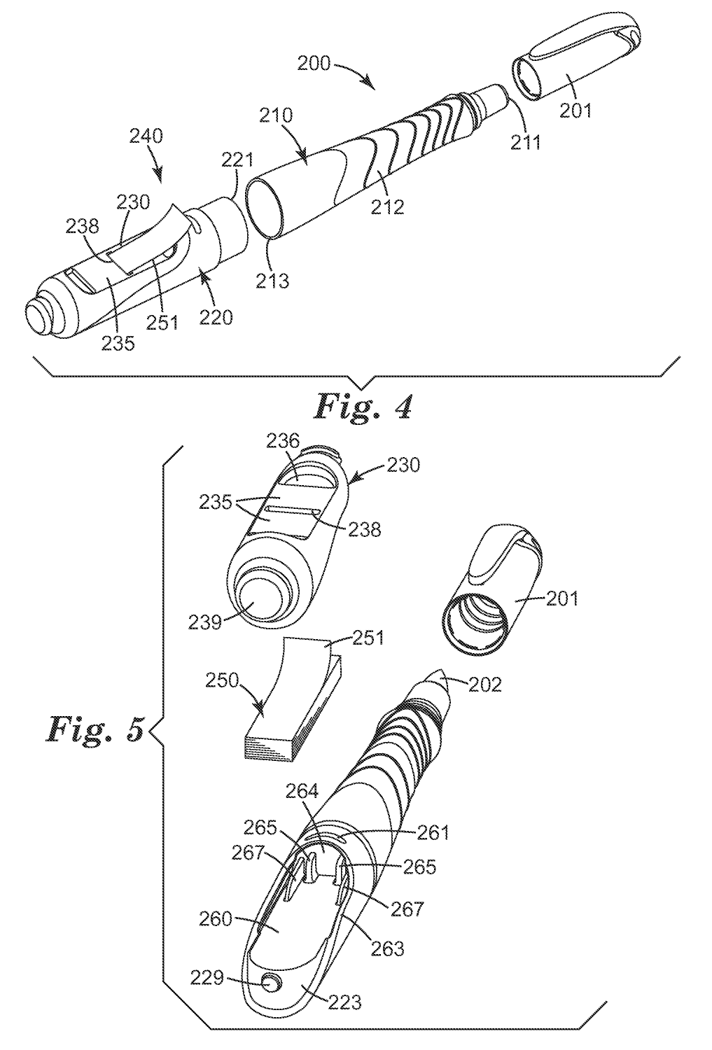

FIG. 4 depicts a perspective view of an unassembled writing instrument 200 without a writing element. FIG. 5 depicts a perspective view of the writing instrument of FIG. 4 assembled and with a sheet dispenser 240 in an exploded view. The writing instrument 200 has a barrel portion 210 and a dispenser portion 220. In this particular embodiment, the writing instrument is elongated having substantially cylindrical barrel and dispensing portions. The writing instrument has a center axis along its length. The barrel portion has a first end 211, a second end 213, and a gripping portion 212 (shown schematically as striations) disposed between the first and second ends. As shown in FIG. 5, a writing element 202 extends from the first end from the barrel portion. When not in use, a cap 201 mates with the first end of the barrel portion to cover and protect the writing element. The writing element is capable of applying ink or fluid to a document.

The dispenser portion 220 has a first end 221, a second end 223, and a sheet dispenser 240 disposed between the first and second ends. The sheet dispenser includes a cover 230 that mates with a lower member 260 to form a housing for a stack of sheets 250. The stack of sheets has from about 45 to 55% adhesive coverage. The stack of sheets of FIG. 2 can be used in the writing instrument of the present invention. In this embodiment, the cover is removable, allowing a user to load a new stack of sheets when the previous stack has been used. The lower member 260 is an integral part of the dispensing portion. A lateral wall 264 extends from one end of the lower member near the first end 221 of the dispensing portion. Optionally, a set of first alignment ribs 267 and a set end braces 265 extend from the lower member 260 and from the lateral wall 264. While the figures show two of each, if desired, one alignment rib and or one end brace can be used. The dispensing portion also includes an aperture 261 for mating with a latch 231 of the cover. The aperture and latch system illustrate one method for mating the cover to the dispensing portion. Other methods can be used. For example, the cover can be hinged to the dispensing portion. Optionally, the second end 223 of the dispensing portion 220 includes a nub 229 that mates with an aperture 239 of the cover, once it is assembled to the writing instrument. When the writing instrument is assembled, the second end 213 of the barrel portion is in communication with the first end 221 of the dispensing portion.

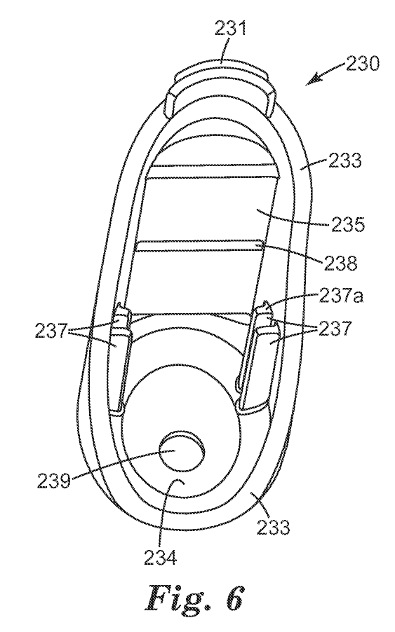

In the exploded perspective view of FIG. 5, the outside of cover, i.e., the side exposed to a user, is shown. In the perspective view of the cover in FIG. 6, the inside of the cover, i.e., the side in contact with the stack of sheets, is shown. The cover includes a top that encompasses a slot 238 disposed substantially transverse to the center axis of the writing instrument. The slot lies about midway along the length of the cover. The slot has a length to allow a sheet in the stack to extend therethrough. The length of the slot is a dimension that lies transverse or perpendicular to the center axis of the writing instrument. The slot has a width dimension that lies substantially parallel to the center axis of the writing instrument. The top of the cover further includes two substantially symmetrical upper walls 235 that straddle the slot. When a stack of sheets are assembled in the sheet dispenser and when a user needs to remove a sheet therefrom, (s)he pulls on a first exposed sheet 251 causing the topmost sheet in the stack to be in direct contact with the upper walls. Optionally, the top of the cover further includes two apertures 236 disposed adjacent to the upper walls 235. Two substantially symmetrical side walls 240 extend from the top of the cover. The cover further includes a rear 234 that extends from both the top and side walls of the cover. In one embodiment, the top, side walls, and rear of the cover are formed as an integral unit. Along the length of the writing instrument, the side wall has a curved profile. In other words, if one were to take a cross-sectional view of the writing instrument with the cover assembled between the slot 238 and the latch 231, it is different than the cross-section between the slot 238 and the rear 234. The rear of the cover can optionally include an aperture 239. Also, the cover can optionally include a set of second alignment devices 237 having a first contact surface 237a, one set on each of the side wall. However, just one set can be used. Optionally, the cover can be made of a transparent material.

When the cover is assembled onto the dispensing portion of the writing instrument, a housing is formed for the stack of sheets. A combination of the set of first alignment devices 267 and of the set of second alignment devices 237, along with the end braces 235 helps the stack of sheets 250 to remain centered with respect to the slot 238. The distance between the first contact surface 237a of the second alignment device 237 and the end brace 265 parallel to the center axis, is the length of the dispenser. At most, the dispenser length is about 110% of the length of the stack of sheets. Thus, when an individual sheet is removed, given the amount of adhesive coverage on each sheet and given the tight tolerance between the length of the dispenser and the length of the stack of sheet, there is little, if any, shuttling of the stack during the sheet removal process.

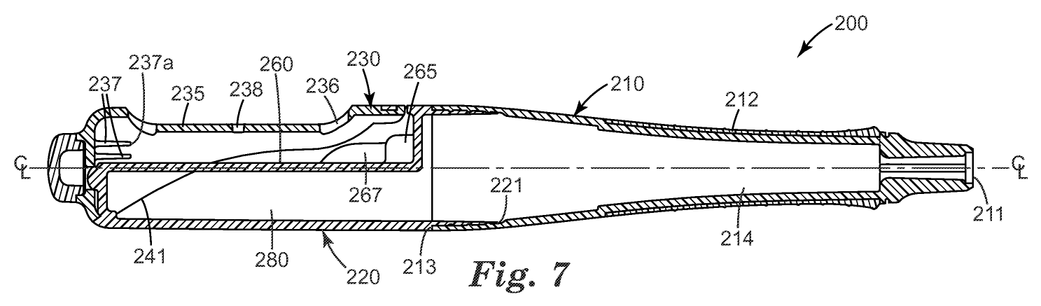

FIG. 7 depicts a cross-sectional view of the embodiment of FIG. 4 with the barrel portion 210 assembled to the dispensing portion 220 but without the writing element and without the cap installed. The writing utensil has a center axis generally denoted as C_{L}. A first cavity 214 of the barrel portion 210 has a center axis that is substantially collinear with the center axis of the writing instrument. The dispensing portion has the sheet dispenser 250 substantially above the center axis. The dispensing portion has a second cavity 280 below the center axis of the writing instrument. The second internal cavity 280 is adjacent to the lower member of the dispenser and in communication with a portion of the first cavity. In one embodiment, the writing element is disposed in the first and second cavities of the barrel and dispensing portions respectively. In this case, as the writing element enters the dispensing portion, it cannot remain along the center axis of the writing instrument because the sheet dispenser 240 would obstruct its path. Thus, the writing element will bend to take a path that is below the center axis into the second cavity. In the barrel portion, the writing element will lie substantially collinear with the centerline axis of the writing instrument. In the dispensing portion, the writing element can be centered along the second cavity 280. In another embodiment, the writing element lies only in the first cavity. This figure also shows that the side walls of the cover 230 has a curved profile shown as line 234, when viewing the writing instrument from the either the right or left side view.

The adhesive used on the sheets of the present invention can be a variety of materials. The adhesive can be a pressure sensitive adhesive. The adhesive can also be a pressure sensitive repositionable adhesive. One suitable repositionable adhesive is a microsphere-based adhesive. An exemplary microsphere-based adhesive includes polyacrylic derivatives. The repositionable adhesive can be solvent based, water based, or can be a solventless, hot melt adhesive. Suitable repositionable adhesives includes those disclosed in the following U.S. Pat. Nos. 3,691,140 (Silver); 3,857,731 (Merrill et al.); 4,166,152 (Baker et al.); 4,495,318 (Howard); 5,045,569 (Delgado); 5,073,457 (Blackwell) and 5,571,617 (Cooprider et al.), 5,663,241 (Takamatsu et al.); 5,714,327 (Cooprider et al.); U.S. RE 37,563 (Cooprider et al.); and 5,756,625 (Crandall et al.); 5,824,748 (Kesti et al.); and 5,877,252 (Tsujimoto et al.).

### EXAMPLES

### Dispensing Force Test Method

The force required to dispense a polymeric sheet, having dimensions of 0.375 inch (9.5 mm) wide by 1.75 inch (44.4 mm) long, from a stack of sheets was done using an Instron machine. The sheets were stacked in a fan-fold configuration. The stack was held in a dispenser integrated with a writing instrument, such as a Post-it® Flag Highlighter, available from 3M Company. U.S. Pat. No. 6,179,472 shows a schematic view of the dispenser used in this testing. The dispenser had a length of about 2.3 inch (59 mm) with a slot width of about 0.0625 inch (1.6 mm).

The highlighter was attached to the Instron fixture using double sided tape. In addition, two pieces (about 5 inches in length) of Scotch® Magic tape, product no. 810, was used to further secure the highlighter to the fixture. The two tape pieces straddled the dispenser region of the highlighter.

The tab end portion of the sheet was fed into the jaws of the Instron fixture, which pulled the tab end portion from stacks of sheets inside the dispenser at a rate of about 100 inches per minute. This type of testing is similar to a 90 peel test commonly used in evaluating peel adhesion. The peak force required to dispense the sheet was then recorded in gram-force.

### Example 1

The dispenser discussed in the “Dispensing Force Test Method” above was retrofitted with two spacers, each about 7.6 mm in length and 9.5 mm wide. Each spacer was used to block an end of the dispenser. Thus, the effective length of the dispenser was about 43.8 mm, or a reduction of about 25% from the original length.

A stack of sheets, each sheet having about 50% coverage of repositionable adhesive on its second surface and its adhesive end portion, was placed in the retrofitted dispenser with the tab end portion extending through the slot. The peak dispensing force required to remove an individual sheet from the dispenser through the slot was measured. Three different stacks of sheet were used, each stack having about 50 sheets. In the first two stacks, eight samples each were tested (for a total of 16 sheets) and in the third stack, nine samples were tested, for a sum total of 25 samples for the three stacks. The peak load required to dispense each sample is reported in Table 1 along with the average of the peak load values.

### Comparative Example A

This example was done as in Example 1 above except that each of the flag had a minimum repositionable adhesive coverage of greater than about 60% (on average, about 63%) on its second surface at its second end. Again, as in Example 1 above, three different stacks were used for a total of 25 samples. The stacks were manufactured by 3M Company, St. Paul, Minn. and sold as part of the Post-it® Flag Highlighter as flag refills. The peak load required to dispense each sample is reported in Table 1 along with the average of the peak load values.

TABLE 1
Dispensing Force

| | Example 1 | Comparative Ex. A |
|---|---|---|
| Sample No. | (gm-force) | (gm-force) |
| 1 | 77.5 | 776.8 |
| 2 | 88.4 | 660.5 |
| 3 | 11.2 | 953.2 |
| 4 | 91.6 | 977.6 |
| 5 | 73.5 | 905.4 |
| 6 | 80.3 | 970.8 |
| 7 | 76.7 | 959.1 |
| 8 | 79.6 | 630.1 |
| 9 | 70.5 | 690.5 |
| 10 | 70.4 | 952.2 |
| 11 | 73.1 | 974.2 |
| 12 | 71.3 | 638.6 |
| 13 | 69.7 | 711.2 |
| 14 | 67.7 | 959.7 |
| 15 | 72.3 | 969.3 |
| 16 | 97.3 | 627.6 |
| 17 | 73.7 | 610.4 |
| 18 | 65.0 | 558.9 |
| 19 | 66.2 | 728.5 |
| 20 | 77.1 | 858.9 |
| 21 | 66.9 | 952.1 |
| 22 | 65.2 | 492.3 |
| 23 | 69.9 | 653.5 |
| 24 | 88.2 | 793.7 |
| 25 | 64.2 | 952.5 |
| Average | 74.9 ± 8.7 | 749.3 ± 160.6 |

As the data in Table 1 shows, the dispensing force for the inventive compact, non-shuttling dispenser, as embodied in Example 1, is about an order of magnitude less than the dispensing force for a prior art flag, i.e., a flag having on average about 63% adhesive coverage on its second side, dispensed through the same compact non-shuttling dispenser. While the prior art flag can be dispensed through the non-shuttling dispenser of the present invention, the pulling force required to remove (i.e., to dispense) the flag is on average about 749 grams, which is similar to having a consumer forcefully yank the flag out of the dispenser. Such a high dispensing force is undesirable.

What is claimed is:

1. A writing instrument having a center axis and comprising:
a barrel portion having opposing first and second ends, an exterior grip surface disposed therebetween, and a first internal cavity;
a marking element extending from the first end of the barrel portion and disposed in the first internal cavity;
a dispensing portion having opposing first and second ends, the first end of the dispensing portion in communication with the second end of the barrel portion, the dispensing portion comprising:
a sheet dispenser comprising (a) a cover having (i) a top joined by two substantially symmetrical sidewalls and a back, each sidewall having a curved profile, the back abutting the second end of the dispenser portion, (ii) a slot disposed about midway along the top and transverse to the center axis of the writing instrument, and (iii) a securing mechanism for attaching to the cover to the dispensing portion; and (b) a lower member integrated into the dispenser portion such that when the cover is attached to the dispensing portion, a housing is formed between the cover and the lower member; and
a second internal cavity adjacent to the lower member of the dispenser and in communication with a portion of the first cavity.

2. The writing instrument of claim 1 further comprising a stack of sheets, the stack having a length dimension along its major axis, each sheet in the stack being releasably adhered to one another in a fan-fold configuration and disposed in the housing, each sheet comprising:
a tab end portion, an adhesive end portion, and opposing first and second surfaces, and
a coating of repositionable adhesive disposed on the adhesive end portion of the second surface of each sheet, the adhesive covering from about 45% to 55% of the second surface.

3. The writing instrument of claim 2, wherein the slot width in the cover is from about 1% to 10% of the length of the stack of sheets.

4. The writing instrument of claim 2, wherein the dispenser has a length, as measured from a first lateral end wall to a second lateral end wall, which is at most 110% of the length of the stack of sheets.

5. The writing instrument of claim 2, wherein for each sheet, the tab end portion and the adhesive end portion meet at an interface that is aligned generally underneath the slot of the cover.

6. The writing instrument of claim 2, wherein the adhesive end portion of each sheet is brightly colored and is of a different color than the first portion of the sheet.

7. The writing instrument of claim 2, wherein the slot width is from about 1% to 5% of the length of the stack of sheets.

8. The writing instrument of claim 2, wherein upon the removal of a first sheet from the stack, a next adjacent sheet in the stack begins the dispensing process by being folded in the slot.

9. The writing instrument of claim 2, wherein a bottom most sheet in the stack is not attached to the lower member of the dispenser.

10. The writing instrument of claim 2, wherein the repositionable adhesive is a polyacrylate, microsphere-based adhesive.

11. The writing instrument of claim 2, wherein the sheet in the stack of sheets is selected from the group consisting of paper, synthetic paper, cellulose acetate, and polypropylene.

12. The writing instrument of claim 2, wherein the first surface of the sheet in the stack of sheet is writable.

13. The writing instrument of claim 1, wherein the cover is transparent.

14. The writing instrument of claim 1, wherein the adhesive covers about 50% of the second surface.
